(19) United States
(12) Patent Application Publication
(10) Pub. No.: US 2008/0002858 A1
(43) Pub. Date: Jan. 3, 2008

(54) Photogrammetric mapping of inaccessible terrain

(75) Inventor: Menachem Devir, Kiryat Motzkin (IL)

Correspondence Address: DR, MARK FRIEDMAN LTD.;C/o Bill Polkinghorn, 9003 Florin Way, Upper Marlboro, MD, 20772, US

(73) Assignee: RAFAEL - ARMAMENT DEVELOPMENT AUTHORITY LTD.

(21) Appl. No.: 11/453,073

(22) Filed: Jun. 15, 2006

(51) Int. Cl. G06K 9/00

(52) U.S. Cl. 382/109; 701/213

(57) ABSTRACT

A device for establishing a ground control point photogrammetry. The Device includes a signaling mechanism for providing a photographically recordable signature, and a navigation mechanism for determining absolute geographic coordinates of the signaling mechanism.

### FIELD AND BACKGROUND OF THE INVENTION

The present invention relates to photogrammetry and, more particularly, to a device that facilitates photogrammetric mapping of inaccessible terrain and a method of using that device.

FIG. 1 illustrates the prior art method of photogrammetry for obtaining a digital terrain map (DTM) of a terrain 12. Terrain 12 is photographed from two different vantage points above terrain 12, to provide two respective images of terrain 12 from the two vantage points. In the example illustrated in FIG. 1, terrain 12 is photographed by two aerial platforms 10 at the two different vantage points. Standard well-known stereo correlation algorithms are used to transform the two images into a relative DTM that is a map of terrain 12 up to a scale factor. Altimeters on board aerial platforms 10 measure the altitudes of aerial platforms 10 relative to terrain 12. The measured relative altitudes are used to compute the correct scale factor that makes distances between points of the DTM equal to the true distance between corresponding points of terrain 12. Note that aerial platforms 10 need not be directly above terrain 12 as long as the vantage points of aerial platforms 10 provide adequate views of terrain 12.

At this point, the DTM is a map of the true shape and size of terrain 12, but not of the location and orientation of terrain 12 in the real world. In other words, the coordinates of the DTM are scaled correctly but still are not absolute geographic coordinates. To transform the coordinates of the DTM to absolute geographic coordinates (latitude, longitude and altitude, or their equivalents), it is necessary to determine the absolute geographic coordinates of at least three non-collinear “ground control points” 14 that are mapped in the DTM. This is done independently of the photographing of terrain 12, for example by surveying ground control points 14. With the absolute geographic coordinates of ground control points 14 known, it is trivial to transform all the coordinates of the DTM to absolute geographic coordinates. In FIG. 1, ground control points 14 are illustrated as local elevation maxima; but any suitable landmarks could be used as ground control points 14.

Alternatively, both the scale factor and the location and orientation of terrain 12 in the real word are determined from the absolute geographic coordinates of ground control points 14. The scale factor can be inferred from the absolute geographic coordinates of ground control points 14 because those absolute geographic coordinates define the true size of the polygon whose vertices are at ground control points 14.

This photogrammetric mapping method is feasible as long as terrain 12 is accessible for surveying ground control points 14, but not if terrain 12 is inaccessible. For example, terrain 12 may be behind enemy lines. There is thus a widely recognized need for, and it would be highly advantageous to have, a photogrammetric method of mapping terrains 12 such that independent surveying of ground control points 14 in those terrains 12 is difficult or impossible.

### SUMMARY OF THE INVENTION

According to the present invention there is provided a device for establishing a ground control point for photogrammetry, including: (a) a signaling mechanism for providing a photographically recordable signature; and (b) a navigation mechanism for determining absolute geographic coordinates of the signaling mechanism.

According to the present invention there is provided a method of mapping a terrain, including the steps of: (a) placing at least three ground control point establishing devices at respective locations on the terrain; and (b) for each of the at least three ground control point establishing devices: (i) determining respective absolute geographic coordinates of the each ground control point establishing device, and (ii) photographing a respective photographically recordable signature of the each ground control point establishing device from at least a first vantage point above the terrain.

The device of the present invention is a ground control point emulation unit that functions as a self-surveying landmark for photogrammetric mapping. Three such devices are introduced to an inaccessible terrain 12, and then are used instead of landmarks 14 as ground control points.

The basic device of the present invention includes a signaling mechanism for providing a photographically recordable signature of the device and a navigation mechanism for determining the absolute geographic coordinates of the signaling mechanism. A photographically recordable signature is a signal in a wavelength band that can be recorded photographically, either by analog photography, in which the light-sensitive medium typically is photographic film, or by digital photography, in which the light-sensitive medium typically is a charge coupled detector (CCD) array for photography in visible light or an analogous array of infrared sensors for photography in infrared light. The wavelength bands used typically are in the visible or infrared portions of the electromagnetic spectrum. That the signal is a “signature” means that the signal is tied to, and directly indicative of, the location of the signaling mechanism. For example, a flare gun would not be such a signaling mechanism because the flare fired from the flare gun moves with respect to the flare gun.

Preferably, the signaling mechanism is transient, meaning that the photographically recordable signature lasts only long enough to be photographed.

In one embodiment of the device of the present invention, the signaling mechanism includes an explosive charge. In another embodiment of the device of the present invention, the signaling mechanism includes a source of photographically recordable light. Preferably, this light source is azimuthally omnidirectional. Preferably, this light source is operative to provide an indication of the absolute geographic coordinates determined by the navigation mechanism, for example by modulating the emitted light so as to digitally encode the absolute geographic coordinates in the emitted light. In yet another embodiment of the device of the present invention, the signaling mechanism includes a refrigerator, i.e., a mechanism for producing local cooling in the immediate vicinity of the device. Such local cooling is recordable by infrared photography.

Preferably, the navigation mechanism includes a GPS receiver. Alternatively or additionally, the navigation mechanism includes an inertial navigation system.

Preferably, the device of the present invention includes a transmitter for transmitting the absolute geographic coordinates determined by the navigation mechanism. Most preferably, the transmitter is an RF transmitter.

Preferably, the device of the present invention includes a receiver for receiving a trigger signal that triggers the signaling mechanism. Most preferably, the receiver is an RF receiver.

The method of the present invention is a method of mapping a terrain. The basic method of the present invention includes three steps.

In the first step, at least three ground control point establishing devices are placed at three respective locations on the terrain.

In the second step, the respective absolute geographic coordinates of each ground control point establishing device is determined, and a respective photographically recordable signature of each ground control point establishing device is photographed from at least one vantage point above the terrain. The photography could be digital, in which case the light-sensitive recording medium is a sensor array such as a CCD array, or analog, in which case the light-sensitive recording medium is photographic film.

In the third step, the terrain is photographed from at least a second and third vantage point above the terrain. Normally, the first and second vantage points are substantially identical. As in the prior art, for the images thus acquired to be suitable for input to a stereo correlation algorithm, the second and third vantage points must be different. Also as in the prior art method, the vantage points need not be directly above the targeted terrain as long as these vantage points provide adequate views of the targeted terrain.

Preferably, the photography is effected by at least one elevated platform, for example by one or more aerial platforms. The photography could be effected using a single elevated platform located at respective vantage points at at least two different times. Preferably, the photography from the second and third vantage points is effected substantially simultaneously by two elevated platforms, each elevated platform then being located at a respective one of the second and third vantage points.

Preferably, the ground control point establishing devices are devices of the present invention. So, for example, the absolute geographic coordinates of each ground control point establishing device are determined using a respective navigation mechanism, for example a respective GPS receiver or a respective inertial navigation system.

Similarly, the method of the present invention preferably includes the step of providing, for each ground control point establishing device, the associated respective signature, preferably as done by the devices of the present invention: by detonating an explosive charge, by cooling the immediate vicinities of the devices or by emitting photographically recordable light. Optionally, the emitted light is modulated in a manner that indicates the absolute geographic coordinates of the associated ground control point establishing device.

Furthermore, the method of the present invention preferably includes the step of transmitting the absolute geographic coordinates of each ground control point establishing device, preferably as done by the devices of the present invention: for example, using respective RF transmitters.

### BRIEF DESCRIPTION OF THE DRAWINGS

The invention is herein described, by way of example only, with reference to the accompanying drawings, wherein:

FIG. 1 is an illustration of prior art photogrammetric mapping;

FIGS. 2-4 are schematic illustrations of three devices of the present invention.

### DESCRIPTION OF THE PREFERRED EMBODIMENTS

The present invention is of a device and an associated method which can be used for photogrammetric mapping. Specifically, the present invention can be used to map inaccessible terrain.

The principles and operation of photogrammetric mapping according to the present invention may be better understood with reference to the drawings and the accompanying description.

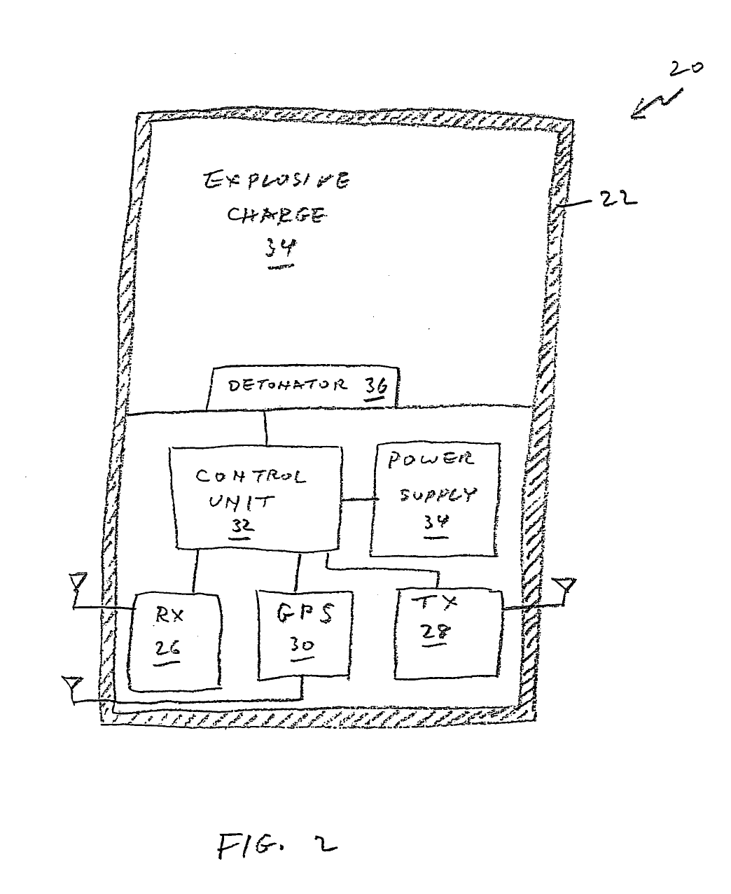

Referring again to the drawings, FIG. 2 is a schematic illustration, partly in block diagram form, of a first embodiment 20 of a device of the present invention. Inside a ruggedized housing 22 are mounted a control unit 32, a power supply 34, a GPS receiver 30, an RF transmitter 28 and an RF receiver 26. The upper half of housing 22 is occupied by an explosive charge 34 that is detonated by a detonator 36. Control unit 32 receives operating power from power supply 34. GPS receiver 30, RF transmitter 28, RF receiver 26 and detonator 36 also receive operating power from power supply 34, via control unit 32. Control unit 32 operates the other components of device 20 as described below.

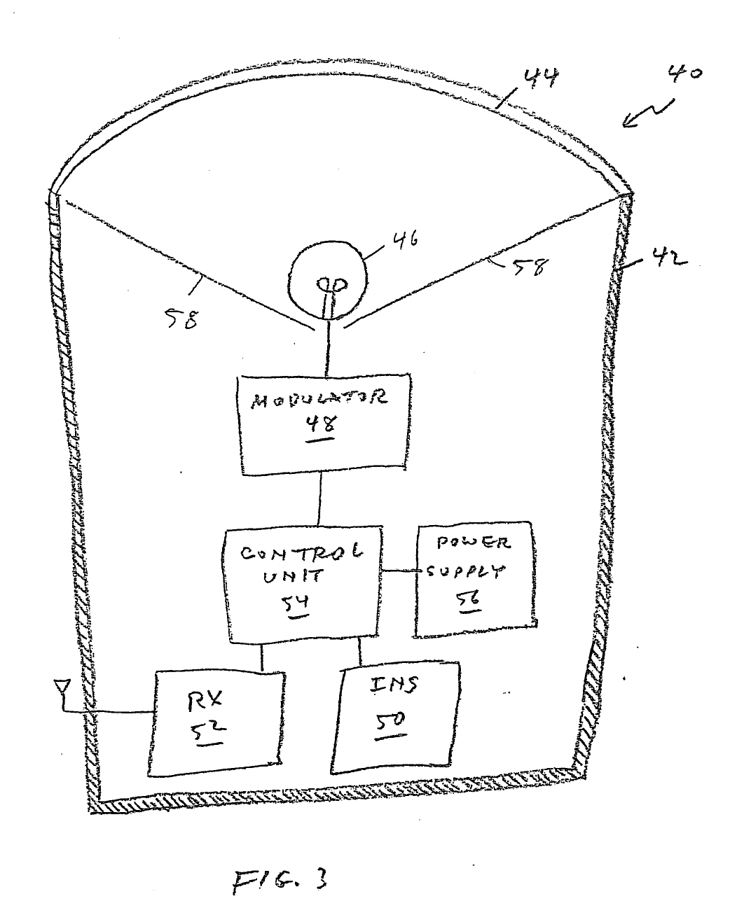

FIG. 3 is a schematic illustration, also partly in block diagram form, of a second embodiment 40 of a device of the present invention. Inside a ruggedized housing 42, that is surmounted by a transparent dome 44, are mounted a control unit 54, a power supply 56, an inertial navigation system 50, a RF receiver 52, a modulator 48, a light source 46 and an opaque shield 58. Control unit 32 receives operating power from power supply 56. Inertial navigation system 50, RF receiver 52, modulator 48 and light source 46 also receive operating power from power supply 56, via control unit 54. Control unit 54 operates the other components of device 40 in much the same fashion as control unit 32 operates the other components of device 20, as described below. For now it suffices to point out that the main difference between devices 20 and 40 lies in their respective photographically recordable signatures. The signature of device 20 is the flash of the explosion of explosive charge 34. As such, the signature of device 20 is a transient signature. The signature of device 40 is light emitted by light source 46. To this end, light source 46 is sufficiently bright to be recorded photographically from the appropriate distance for the photogrammetric survey in which device 40 is used. In one variant of device 40, light source 46 includes a xenon flash lamp. In another variant of device 40, light source 46 includes a LED.

GPS receiver 30 usually is preferred to inertial navigation system 50 because GPS receiver 30 is inherently more accurate than inertial navigation system 50. Inertial navigation system 50 must be initialized with its absolute geographic coordinates before it is deployed. Then, while inertial navigation system 50 is deployed, errors in the measured absolute geographic coordinates accumulate. The advantage of inertial navigation system 50 over GPS receiver 30 is that for GPS receiver 30 to determine its absolute geographic coordinates GPS receiver 30 must receive signals of adequate strength from an adequate number of GPS satellites.

In a variant of device 40 intended for use behind enemy lines, light source 46 emits only infrared light, so as not to be easily visible to enemy soldiers. To this end, if light source 46 is a xenon lamp, light source 46 also includes a filter that blocks visible radiation. Alternatively, dome 44 is transparent to infrared light but not to visible light. In addition, also to reduce the visibility of device 40 to enemy soldiers, device 40 includes opaque shield 58 that, along with housing 42, ensures that, although device 40 emits light in all azimuthal directions, device 40 emits light only upwards and not to the sides.

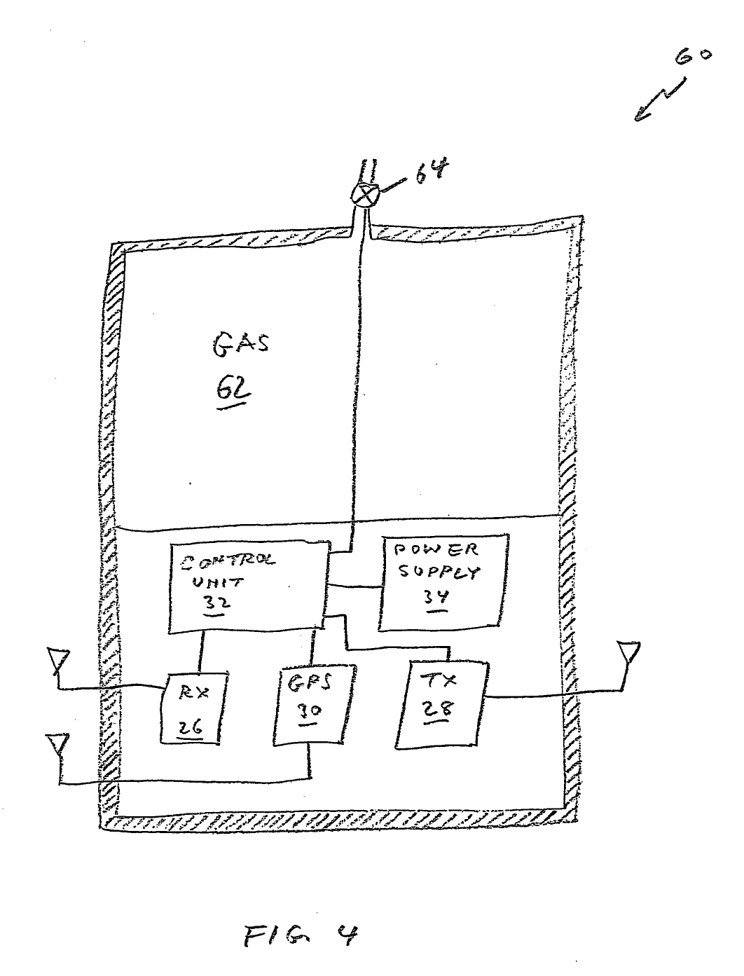

FIG. 4 is a schematic illustration, also partly in block diagram form, of a third embodiment 60 of a device of the present invention. Device 60 is substantially identical to device 20, except that instead of explosive charge 34 and detonator 36, device 60 has a tank of a gas 62 such as air, nitrogen or argon at high pressure and a release valve 64. When control unit 32 opens valve 64, gas 62 rushes out of valve 64. The resulting expansion of gas 62 creates a cold plume, immediately above device 60, that is recordable by infrared photography.

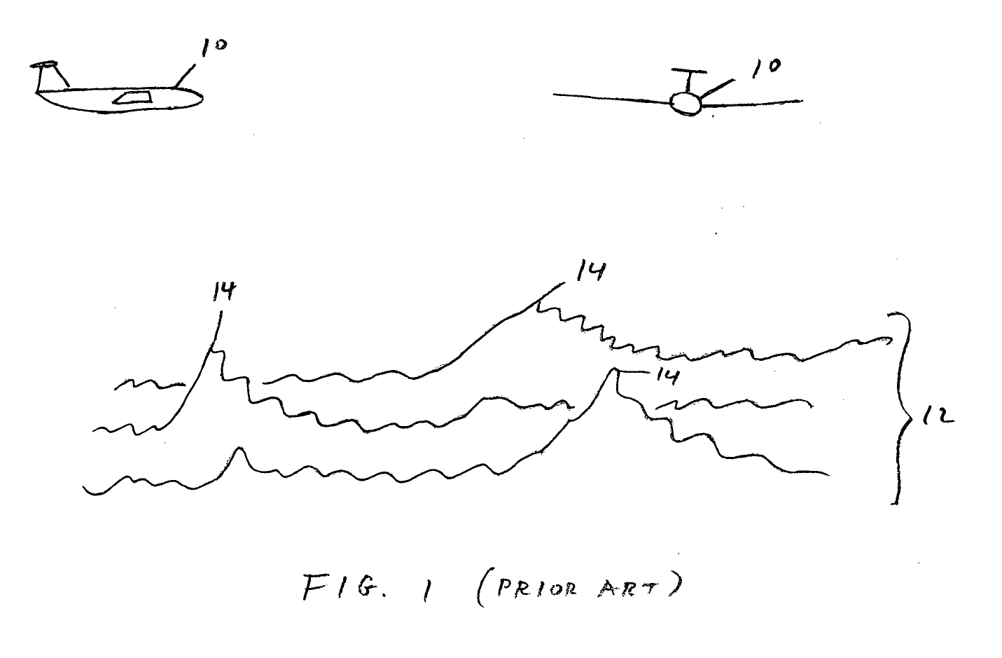

FIG. 1, in addition to illustrating the prior art method of photogrammetric mapping, also illustrates the method of the present invention, with the understanding that devices 20, 40 or 60 are substituted for landmarks 14. Three embodiments of the method of the present invention for conducting a photogrammetric survey are presented below. All three embodiments start with the same first step: deploying at least three devices 20, 40 or 60 non-collinearly in the targeted terrain. If the photogrammetric survey is to be conducted behind enemy lines, devices 20, 40 or 60 are emplaced by secret agents. Alternatively, devices 20, 40 or 60 are dropped onto terrain 12 by aerial platforms 10. To be usable under the alternative deployment method, devices 40 and 60 must be configured to land right-side-up, or at least to right themselves after landing.

The first embodiment of the present invention uses two aerial platforms 10 and three or more devices 20 or 60. One of aerial platforms 10 signals devices 20, via RF receivers 26, to turn on GPS receivers 30 so as to measure the absolute geographic coordinates of devices 20 or 60. As is known in the art, such measurements often require several seconds to perform, depending on how many GPS satellites are visible to each device 20 or 60 and on the strength of the signals from those satellites. As soon as each device 20 or 60 has obtained a fix of its absolute position, that device 20 or 60 transmits its absolute geographic coordinates to the interrogating aerial platform 10, using RF transmitter 28.

When all the deployed devices 20 or 60 have finished transmitting their absolute geographic positions, one of aerial platforms 10 issues a command to all the deployed devices 20 to detonate their explosive charges 34, using detonators 36, or to all deployed devices 60 to open their valves 64 to release gas 62. At the same time, both aerial platforms 10 photograph the targeted terrain from their respective vantage points. The two respective photographic images acquired by the two aerial platforms 10 include records of the signature flashes of the explosions of explosive charges 34 of devices 20 or of the signature cold plumes of gas 62 of devices 60. A standard stereo correlation algorithm is used to convert the photographic images to a relative DTM of terrain 12 as described above. Except in degenerate cases (e.g., three devices 20 or 60 deployed at the vertices of an equilateral triangle), there is enough information in the relative DTM of terrain 12 obtained from the two images to associate each signature flash or cold plume with its respective absolute geographic coordinates. The signature flashes or cold plumes then serve as ground control points for transforming the coordinates of the DTM to absolute geographic coordinates, i.e., to provide and absolute DTM of terrain 12.

Alternatively, only one aerial platform 10 is used. Aerial platform 10 signals devices 20 or 60 to measure their absolute geographic coordinates as described above. Devices 20 or 60 transmit their absolute geographic coordinates to aerial platform 10. Aerial platform 10 then issues a command to all the deployed devices 20 or 60 to produce their photographically recordable signatures (the flashes of the explosions of explosive charges 34 or the cold plumes of gas 62). As the deployed devices 20 or 60 produce their photographically recordable signatures, aerial platform 10 photographs the targeted terrain from its vantage point while using its on-board navigation system to measure both its own absolute geographic coordinates and its own absolute orientation. Then, aerial platform 10 flies to a second vantage point that is different from the first vantage point and photographs the targeted terrain again while using its on-board navigation system to measure both its own absolute geographic coordinates and its own absolute orientation. Based on the absolute positions and orientations of aerial platform 10 at both vantage points, the locations, in the terrain image that is acquired at the second vantage point, where the photographically recordable signatures would have been recorded if the deployed devices 20 or 60 had produced their photographically recordable signatures while aerial platform 10 was at the second vantage point, are computed by triangulation. A standard stereo correlation algorithm is used to convert the photographic images to a relative DTM of terrain 12 as described above. As before, the signature flashes or cold plumes serve as ground control points, via their actual records in the first photographic image and their inferred locations in the second photographic image, for transforming the coordinates of the DTM to absolute geographic coordinates.

In variants of the first embodiment that normally are less preferred but that may be necessary under some circumstances, photography of the signatures of deployed devices 20 or 60 is separated from photography of terrain 12. For example, a single aerial platform 10 may be used to photograph the signatures from a first vantage point and then to photograph terrain 12 from second and third vantage points that are different from each other and from the first vantage point. At all three vantage points, aerial platform 10 uses its on-board navigation system to measure is both its own absolute geographic coordinates and its own absolute orientation. The locations, in the two terrain images, where the photographically recordable signatures would have been recorded if the deployed devices 20 or 60 had produced their photographically recordable signatures while aerial platform 10 was at the second and third vantage points, are computed by triangulation. A standard stereo correlation algorithm is used to convert the terrain images to a relative DTM of terrain 12, and the signature flashes or cold plumes serve as ground control points, via their inferred locations in the terrain images, for transforming the coordinates of the DTM to absolute geographic coordinates.

In a second less preferred variant, two aerial platforms 10 are used. The first aerial platform 10 photographs the signatures from a first vantage point. The second aerial platform 10 photographs terrain 12 from second and third vantage points. The second and third vantage point must be different from each other, but one of the second or third vantage points may be the same as the first vantage point. A DTM with absolute geographic coordinates is produced from the two images of terrain 12 as in the first less preferred variant.

The second embodiment uses one aerial platform 10 and three or more devices 40. Aerial platform 10 signals devices 40, via RF receivers 52, to turn on their light sources 46. In each device 40, control unit 54 obtains the absolute geographic coordinates of that device 40 from inertial navigation system 50 and uses modulator 48 to modulate the light emitted by light source 46 in a manner that encodes the absolute geographic coordinates of that device 40 in that emitted light. An optical sensor on board aerial platform 10 receives these optical signals, and a processor on board aerial platform 10 decodes the signals to obtain the absolute geographic coordinates of devices 40.

Now aerial platform 10 flies to a first vantage point above terrain 12 and photographs terrain 12. The resulting photographic image includes records of the light emitted by devices 40, as signatures of devices 40. Then, while devices 40 continue to emit their signature light, aerial platform 10 flies to a second vantage point above terrain 12 and photographs terrain 12. Again, the resulting photographic image includes records of the light emitted by devices 40, as signatures of devices 40. Further processing of the two photographic images to obtain an absolute DTM is as in the first variant of the embodiment.

Alternatively, aerial platform 10 signals devices 40 to turn off their light sources 46 after aerial platform 10 has photographed terrain 12 from the first vantage point. At both the first and second vantage points, aerial platform 10 uses its on-board navigation system to measure both its own absolute geographic coordinates and its own absolute orientation. Only the first photographic image of terrain 12 then includes records of the light emitted by devices 40; but the locations in the second photographic image of terrain 12, where records of the light emitted by devices 40 would have been if devices 40 had continued to emit light, are determined as in the second variant of the first embodiment. Further processing of the two photographic images to obtain an absolute DTM is as in the second variant of the first embodiment.

The third embodiment uses one or two aerial platforms 10, and either devices 20 or devices 40 or devices 60, but devices 20, 40 or 60 are operated sequentially rather than simultaneously. For definiteness, the third embodiment will be described in terms of two aerial platforms 10 and n≧3 devices 20. First, one of aerial platforms 10 signals a device 20, via RF receiver 26, to turn on GPS receiver 30 so as to measure the absolute geographic coordinates of that device 20. When that device 20 has obtained a fix of its absolute position, that device 20 transmits its absolute geographic coordinates to the interrogating aerial platform 10, using RF transmitter 28. Then one of aerial platforms 10 issues a command to that device 20 to detonate its explosive charge 34. At the same time, either both aerial platforms 10 photograph a portion of terrain 12, including the flash from the explosion of explosive charge 34, from their respective vantage points; or one aerial platform 10 photographs the portion of terrain 12, including the flash from the explosion of explosive charge 34, from a first vantage point, followed by photography by the same aerial platform 10 or by a second aerial platform 10 of the same portion of terrain 12 but not including the flash from the explosion of explosive charge 34, from a second vantage point different from the first vantage point. In the latter case of sequential photography of the portion of terrain 12 in which that device 20 is located, while the aerial platform(s) 10 photograph(s) that portion of terrain 12, the aerial platform(s) 10 also use its/their on-board navigation system(s) to measure its/their respective absolute geographic coordinates and its/their absolute orientations. This is repeated for all n devices 20.

2n photographic images thus have been acquired, of respective portions of terrain 12. In each photographic image, either a record of a signature of a device 20 tied to a known absolute geographical location appears, or the absolute location of that device 20 can be inferred as described above. The n portions of terrain 12 are chosen to overlap. Known stereo correlation algorithms are used, in conjunction with known algorithms that cross-correlate photographic images that correspond to overlapping portions of terrain 12 so as to chain the photographic images together, to transform these images to an absolute DTM of terrain 12.

While the invention has been described with respect to a limited number of embodiments, it will be appreciated that many variations, modifications and other applications of the invention may be made.

What is claimed is:

1. A device for establishing a ground control point for photogrammetry, comprising:
(a) a signaling mechanism for providing a photographically recordable signature; and
(b) a navigation mechanism for determining absolute geographic coordinates of said signaling mechanism.

2. The device of claim 1, wherein said signaling mechanism is transient.

3. The device of claim 1, wherein said signaling mechanism includes an explosive charge.

4. The device of claim 1, wherein said signaling mechanism includes a source of photographically recordable light.

5. The device of claim 4, wherein said source is azimuthally omnidirectional.

6. The device of claim 4, wherein said source is operative to provide an indication of said absolute geographical coordinates.

7. The device of claim 1, wherein said signaling mechanism includes a refrigerator.

8. The device of claim 1, wherein said navigation mechanism includes a GPS receiver.

9. The device of claim 1, wherein said navigation mechanism includes an inertial navigation system.

10. The device of claim 1, further comprising:
(c) a transmitter for transmitting said absolute geographic coordinates.

11. The device of claim 10, wherein said transmitter is a RF transmitter.

12. The device of claim 1, further comprising:
(c) a receiver for receiving a trigger signal for said signaling mechanism.

13. The device of claim 12, wherein said receiver is a RF receiver.

14. A method of mapping a terrain, comprising the steps of:
(a) placing at least three ground control point establishing devices at respective locations on the terrain; and
(b) for each of said at least three ground control point establishing devices:
(i) determining respective absolute geographic coordinates of said each ground control point establishing device, and
(ii) photographing a respective photographically recordable signature of said each ground control point establishing device from at least a first vantage point above the terrain.

15. The method of claim 14, further comprising the step of:
(c) photographing the terrain from at least a second and third vantage point above the terrain.

16. The method of claim 15, wherein said first and second vantage points are substantially identical.

17. The method of claim 15, wherein said photographing is effected by at least one elevated platform.

18. The method of claim 17, wherein said at least one elevated platform is at least one aerial platform.

19. The method of claim 17, wherein said photographing is effected using a single said elevated platform at at least two different times corresponding to respective said vantage points.

20. The method of claim 17, wherein said photographing from said second and third vantage points is effected substantially simultaneously by two said elevated platforms, each said elevated platform then being at a respective one of said second and third vantage point.

21. The method of claim 14, wherein said photographing is effected by at least one elevated platform.

22. The method of claim 21, wherein said at least one elevated platform is at least one aerial platform.

23. The method of claim 14, wherein, for each said ground control point establishing device, said determining of said absolute geographic coordinates is effected using a respective navigation mechanism.

24. The method of claim 23, wherein said respective navigation mechanisms include respective GPS receivers.

25. The method of claim 23, wherein said respective navigation mechanisms include respective inertial navigation systems.

26. The method of claim 14, further comprising the step of:
(d) for each said ground control point establishing device: providing said respective photographically recordable signature.

27. The method of claim 26, wherein, for each said ground control point establishing device, said respective photographically recordable signature is provided by detonating an explosive charge.

28. The method of claim 26, wherein, for each said ground control point establishing device, said respective photographically recordable signature is provided by emitting photographically recordable light.

29. The method of claim 28, wherein said emitting of said photographically recordable light includes modulating said light in a manner that indicates said absolute geographic coordinates of said respective ground control point establishing device.

30. The method of claim 26, wherein, for each said ground control point establishing device, said respective photographically recordable signature is provided by cooling an immediate vicinity of said each ground control point establishing device.

31. The method of claim 14, further comprising the step of:
(d) for each said ground control point establishing device: transmitting said respective absolute geographic coordinates.

32. The method of claim 30, wherein, for each said ground control point establishing device, said transmitting of said respective absolute geographic coordinates is effected using a respective RF transmitter.
